(19) United States
(12) Patent Application Publication
(10) Pub. No.: US 2018/0050421 A1
(43) Pub. Date: Feb. 22, 2018

(54) Hybrid Laser Cladding System

(71) Applicant: Caterpillar Inc., Peoria, IL (US)

(72) Inventors: Thierry Marchione, Heber City, UT (US); Andrew Steinmetz, Peoria, IL (US)

(73) Assignee: Caterpillar Inc., Peoria, IL (US)

(21) Appl. No.: 15/240,154

(22) Filed: Aug. 18, 2016

(51) Int. Cl. B23K 26/14; B23K 26/34; B23K 26/144

(52) U.S. Cl. CPC B23K 26/1429; B23K 26/144; B23K 26/34

(57) ABSTRACT

A hybrid laser cladding nozzle configured to both powder feed and wire feed a cladding layer onto a substrate surface is disclosed. The hybrid laser cladding nozzle may comprise a central laser channel that is configured to convey a laser beam onto the substrate surface to produce a laser beam spot thereon. The hybrid laser cladding nozzle may further comprise a powder channel coaxial to the laser channel that is configured to feed a powder material onto the laser beam spot, and at least one wire channel laterally disposed with respect to the laser channel and the powder channel that is configured to feed a wire onto the laser beam spot. The laser beam spot may be configured to at least partially melt the powder material and the wire to produce the cladding layer on the substrate surface upon resolidification.

### TECHNICAL FIELD

The present disclosure generally relates to laser cladding and, more specifically, to a hybrid laser cladding system that is capable of both powder feeding and wire feeding.

### BACKGROUND

Laser cladding is a surface treatment technology used in many industries such as construction, agriculture, mining, automotive, marine, power generation, and aerospace industries. As a method of hardfacing, laser cladding may be used to apply a cladding layer that enhances various mechanical and/or chemical properties of a base material, such as the wear, erosion, abrasion, impact, corrosion, and/or oxidation resistance of the base material. In such applications, the base material/substrate surface may be metallic, and the applied cladding layer may include hard particles immersed in a metallic matrix or binder to provide an extremely hard and wear-resistant surface.

In a laser cladding operation, a laser may be projected onto the surface of the substrate, causing a thin layer of the substrate surface to melt and produce a localized “melt pool”. The cladding layer metal matrix/hard particles may be fed into the laser beam and melt pool to cause the cladding layer material to at least partially melt and combine with the melt pool at the substrate surface. Upon resolidification, the cladding layer may be fused to the substrate surface with a strong metallurgical bond.

Currently, the cladding layer material is fed into the melt pool/laser beam in either powder or wire form through a laser cladding nozzle. For example, U.S. Patent Application Number 2006/0065650 discloses a laser cladding nozzle having a hollow central projection for conveying the laser out of the nozzle through an opening, as well as powder channels that feed powdered cladding material out through the opening of the nozzle to the substrate surface. In other nozzle designs, a wire channel may be used instead of a powder channel to feed the cladding material in wire form onto the substrate surface.

The selection of powder or wire feeding is often determined by the material form availability, the material chemistry, the shape and size of the part, among various other considerations. However, powder and wire feeding are both associated with distinct advantages and disadvantages. For instance, wire feeding cannot support more than about 30-35% volumetric fraction of hard particles due to the limiting holding capacity of the wire. In addition, wire feeding is unidirectional, and may result in irregular cladding layer thicknesses due to poor detachment of the wire from the melt pool as may occur, for example, when applying the cladding layer by rastering. In contrast, powder feeding can support a high volumetric fraction of hard particles, and spreads on the substrate surface to provide multidirectional deposition. Moreover, powder feeding does not involve wire detachment and, therefore, may provide a smooth surface with an even thickness. On the other hand, powder feeding may be limited by material form availability, powder material chemistry, as well as the shape and size of the part to be treated.

Thus, a laser cladding nozzle configured for only one of powder or wire feeding may not be optimal for many applications. Accordingly, there is a need for improved laser cladding system designs.

### SUMMARY

In accordance with one aspect of the present disclosure, a hybrid laser cladding nozzle configured to both powder feed and wire feed a cladding layer onto a substrate surface is disclosed. The hybrid laser cladding nozzle may comprise a central laser channel configured to project a laser beam onto the substrate surface to produce a laser beam spot thereon. The hybrid laser cladding nozzle may further comprise a powder channel coaxial to the laser channel that is configured to feed a powder material onto the laser beam spot, and at least one wire channel laterally disposed with respect to the central laser channel and the powder channel. The wire channel may be configured to feed a wire onto the laser beam spot. The laser beam spot may be configured to melt the powder material and the wire to produce the cladding layer on the substrate surface.

In accordance with another aspect of the present disclosure, a hybrid laser cladding system for depositing a cladding layer onto a surface of a substrate by powder feeding and wire feeding is disclosed. The hybrid laser cladding system may comprise a fixture configured to support the substrate, and a laser cladding head having a laser cladding nozzle that includes nozzle tip with a nozzle opening and a wire opening. The laser cladding nozzle may further include a central laser channel configured to project a laser beam through the nozzle opening onto the surface of the substrate to produce a laser beam spot on the surface. In addition, the laser cladding nozzle may further include a powder channel coaxial to the laser channel that is configured to feed a powder material onto the laser beam spot through the nozzle opening, and at least one wire channel laterally disposed with respect to the laser channel and the powder channel that is configured to feed a wire onto the laser beam spot through the wire opening. The laser beam spot may be configured to melt the powder material and the wire to produce the cladding layer on the surface of the substrate. The hybrid laser cladding system may further comprise a laser power supply configured to produce the laser beam, and a hot wire supply configured to preheat the wire in the wire channel.

In accordance with another aspect of the present disclosure, a wear component having a body with a metallic surface and a cladding layer deposited on the surface is disclosed. The cladding layer may be deposited on the surface of the wear component by a method comprising aligning a laser cladding nozzle with the surface, wherein the laser cladding nozzle includes a laser channel, a powder channel coaxial to the laser channel, and at least one wire channel laterally disposed with respect to the laser channel and the powder channel. The method may further comprise projecting a laser beam through the laser channel onto the surface of the component to produce a laser beam spot, and the laser beam spot may at least partially melt the surface to produce a melt pool at the laser beam spot. In addition, the method may further comprise feeding a wire through the wire channel onto the laser beam spot to melt the wire into the melt pool, and feeding a powder material through the powder channel onto the laser beam spot to melt the powder material into the melt pool. The wire may include a metal matrix, and the powder material may include hard particles. The method may further comprise allowing the melt pool to resolidify at the surface of the component to provide the cladding layer.

These and other aspects and features of the present disclosure will be more readily understood when read in conjunction with the accompanying drawings.

### BRIEF DESCRIPTION OF THE DRAWINGS

FIG. 1 is a schematic representation of a portion of a machine having wear components, constructed in accordance with the present disclosure.

FIG. 2 is a side view of one of the wear components of FIG. 1 shown in isolation, constructed in accordance with the present disclosure.

FIG. 3 is a cross-sectional view through the section 3-3 of FIG. 1, constructed in accordance with the present disclosure.

FIG. 4 is a schematic representation of a hybrid laser cladding system, constructed in accordance with the present disclosure.

FIG. 5 is a cross-sectional view of a hybrid laser cladding nozzle of the laser cladding system of FIG. 4, constructed in accordance with the present disclosure.

FIG. 6 is a cross-sectional view similar to FIG. 5, but having a plurality of wire channels, constructed in accordance with the present disclosure.

FIG. 7 is a cross-sectional view similar to FIG. 5, but having a laterally disposed powder channel, constructed in accordance with the present disclosure.

FIG. 8 is a cross-sectional view similar to FIG. 5, but having a coaxial wire channels and a laterally disposed powder channel, constructed in accordance with the present disclosure.

FIG. 9 is a cross-sectional view similar to FIG. 5, but having a coaxial wire channels, constructed in accordance with the present disclosure.

FIG. 10 is a bottom view of the nozzle of FIG. 5, illustrating a nozzle opening and a wire opening, constructed in accordance with the present disclosure.

FIG. 11 is a bottom view similar to FIG. 10, but having four wire openings distributed around the nozzle opening, constructed in accordance with the present disclosure.

FIG. 12 is a bottom view similar to FIG. 10, but having three wire openings distributed around the nozzle opening, constructed in accordance with the present disclosure.

FIG. 13 is a flowchart depicting a series of steps that may be involved in using the hybrid laser cladding system to fabricate a wear component having a cladding layer applied to a surface of the component, in accordance with a method of the present disclosure.

### DETAILED DESCRIPTION

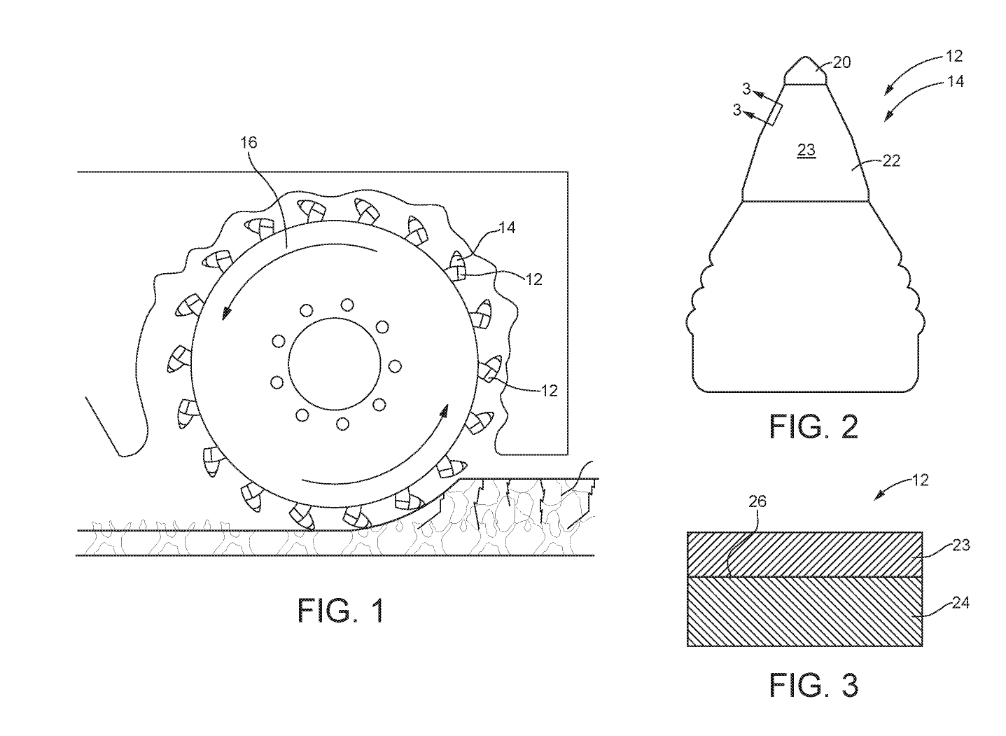

Referring now to the drawings, and with specific reference to FIG. 1, a machine 10 having a plurality of wear components 12 is shown. As a non-limiting example, the machine 10 may be a cold planer, and the wear components 12 may be picks 14 displayed on a rotating drum 16 that grind and remove a paved surface 18 prior to application of a new layer of pavement. If the wear component 12 is a pick 14 for a cold planer machine, it may include a wear-resistant tip 20 and a bolster 22 for supporting the tip 20, as shown in FIG. 2. The bolster 22 may include a cladding layer 23 applied to its surface that contains hard particles for increasing the wear resistance of the component 12. However, it will be understood that the wear component 12 may be many other types of engagement tools subject to wear such as, but not limited to, an electric or non-electric shovel, as well as various cutting or abrading tools, rotating blades, and scraping structures that may be hand-held or associated with a machine.

The material construction of the wear component 12 is depicted in FIG. 3. The wear component 12 may include a body or substrate 24 that is formed from a metallic material such as a metal, a metal alloy, or a metal composite material. Applied to a surface 26 of the substrate 24 may be the cladding layer 23 that serves to enhance the wear resistance of the component 12. The cladding layer 23 may have a thickness ranging from about 0.1 millimeters (mm) to about 10 mm, although the thickness may deviate from this range in some circumstances. The cladding layer 23 may be a composite material that includes one or more hard particles immersed in a metal matrix. As used herein, a “hard particle” is substance having a Vickers hardness of more than about 700 and a size of less than about 3 mm. For instance, the hard particles may be selected from various carbide particles, such as tungsten carbide or chromium carbide, as well as various boride particles, nitride particles, diamond pellets, or combinations thereof. The metal matrix may function as a binder between the surface 26 and the hard particles. Suitable metal matrix compositions may be selected from a range of metals and metal alloys including, but not limited to, iron, nickel, cobalt, titanium, aluminum, alloys of the any of the aforementioned metals, and combinations thereof.

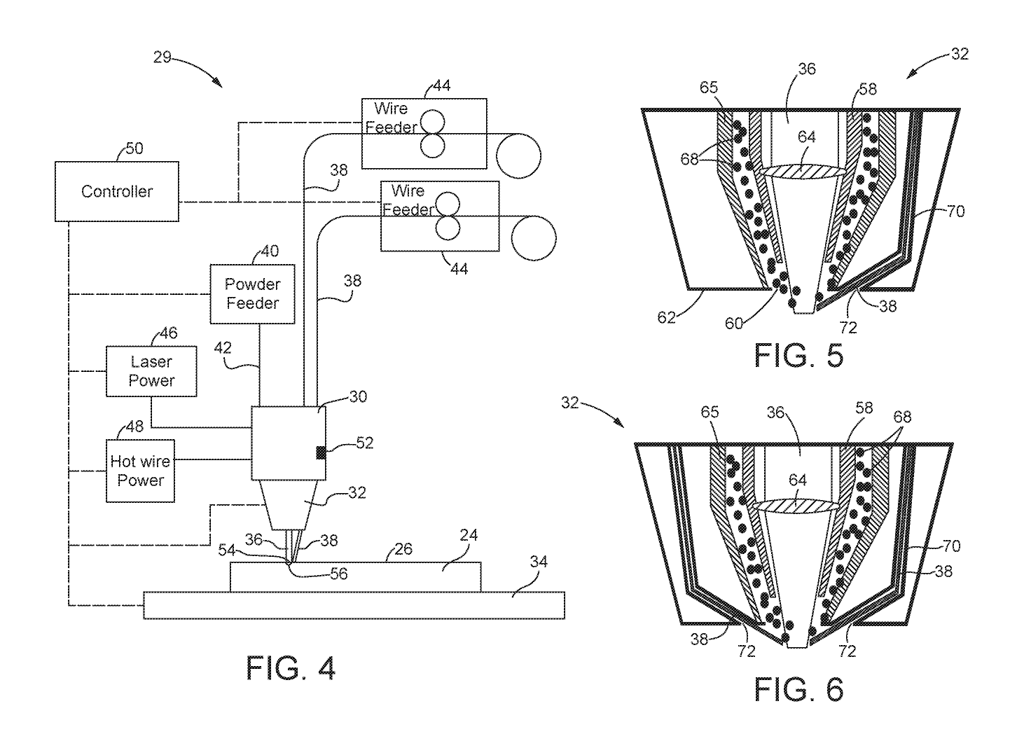

Turning to FIG. 4, a hybrid laser cladding system 29 that may be used to deposit the cladding layer 23 onto the substrate surface 26 is shown. The hybrid laser cladding system 29 may be configured to apply the cladding layer 23 by either or both of powder feeding and wire feeding. The laser cladding system 29 may include a laser cladding head 30 having a hybrid laser cladding nozzle 32. The hybrid laser cladding nozzle 32 may be configured to project a laser beam 36 onto the substrate surface 26, as well as to feed the cladding layer material onto the surface 26 in either or both of powder form and wire form (i.e., as one or more wires 38). By co-feeding both wire and powder, the system 29 may be capable of high deposition rates of at least 20 pounds per hour or more.

The system 29 may further include a fixture 34 for supporting the substrate 24, a powder feeder 40 for supplying powder material to the nozzle 32 via one or more supply conduits 42, as well as one or more wire feeders 44 for feeding the wire(s) 38 to the nozzle 32. Connected to the cladding head 30 may also be a laser power supply 46 which serves as an energy source for producing the laser beam 36. Furthermore, the system 29 may also include a hot wire power supply 48 in connection with the cladding head 30 to preheat the wire(s) 38, such as by resistive heating, to a temperature below its melting point prior to deposition on the substrate surface 26. Preheating of the wire(s) 38 in this way may reduce the energy input required by the laser beam 36 to melt the wire(s) 38.

Optionally, a controller 50 may be in electrical communication with one or more of the wire feeder(s) 44, the powder feeder 40, the laser cladding head 30 (and the nozzle 32), the laser power supply 46, the hot wire power supply 48, and the fixture 34 for automated control thereof. Namely, the controller 50 may control numerous parameters of the laser cladding operation such as the laser power via the laser power supply 46, the preheated temperature of the wire(s) 38 via the hot wire power supply 48, the rate of powder and wire feeding through the powder feeder 40 and the wire feeder(s) 44, respectively, as well as the movement of the fixture 34/substrate 24 relative to the nozzle 32. Moreover, the controller 50 may control whether the system 29 deposits the cladding layer 23 by powder feeding, wire feeding, or by a combination of powder and wire feeding by activating and deactivating the powder feeder 40 and the wire feeder(s) 44 accordingly. In alternative arrangements, the laser cladding system 29 may be manually controlled. For example, the system 29 may include one or more user-actuatable switches 52 that permits a user to select between powder feeding, wire feeding, and a combination of powder feeding and wire feeding. Likewise, the system 29 may also include various other switches/controls that enable a user to select the laser power, the feed rates of the powder feeder 40 and the wire feeder(s) 44, and the movement of the head 30/nozzle 32 with respect to the fixture 34/substrate 24.

In operation of the laser cladding system 29, the laser beam 36 may be projected onto the substrate surface 26 through the nozzle 32 to produce a laser beam spot 54 on the surface 26. The laser beam spot 54 may at least partially melt a thin layer of the surface 26, producing a melt pool 56. As the laser beam 36 is projected onto the surface 26, the cladding layer material (as a powder material and/or as one or more wires 38) may be fed into the laser beam spot 54 and the melt pool 56 through the nozzle 32, allowing the cladding layer material to at least partially melt and combine with the melt pool 56. Upon resolidification, the cladding layer 23 may be fused with the surface 26 of the substrate 24 with a strong metallurgical bond therebetween. The fixture 34/substrate 24 and the nozzle 32 may be moved with respect to each other to cover the desired area of the surface 26 with the cladding material and/or to build up the thickness of the cladding layer 23. In some arrangements, the fixture 34/substrate 24 may be moved relative to the nozzle 32 with the nozzle 32 held stationary. In other arrangements, the nozzle 32 may be moved relative to the fixture 34/substrate 24 while the fixture 34 and the substrate 24 are held stationary.

The hybrid laser cladding nozzle 32 is shown in cross-section in FIG. 5. As shown, the laser cladding nozzle 32 may include a central laser channel 58 that projects the laser beam 36 onto the substrate surface 26 through a nozzle opening 60 at a tip 62 of the nozzle. An optical focusing device, such as one or more lenses 64, may be disposed in the laser channel 58 for focusing the laser beam 36 on the substrate surface 26. In addition, coaxial to the central laser channel 58 may be one or more powder channels 65 that feed a powder material 68 into the laser beam 36 and the melt pool 56 through the nozzle opening 60. Furthermore, as will be understood by those with ordinary skill in the art, an inert carrier gas such as argon, nitrogen, or helium may be used to carry the powder material 68 through the powder channel 65 and into the melt pool 56.

Laterally disposed with respect to the laser channel 58 and the powder channel 65 may be a wire channel 70 that feeds one or more wires 38 into the laser beam 36 and the melt pool 56. The wire 38 may exit the wire channel 70 and the nozzle 32 through a wire opening 72 at the tip 62 that is separate from the nozzle opening 60. To allow multidirectional wire feeding, the nozzle 32 may optionally include a plurality of wire channels 70 laterally distributed around the laser channel 58 and the powder channel 65, and each of the wire channels 70 may be configured to feed its respective wire(s) 38 through a separate wire opening 72 surrounding the nozzle opening 60 (see FIG. 6 and further details below).

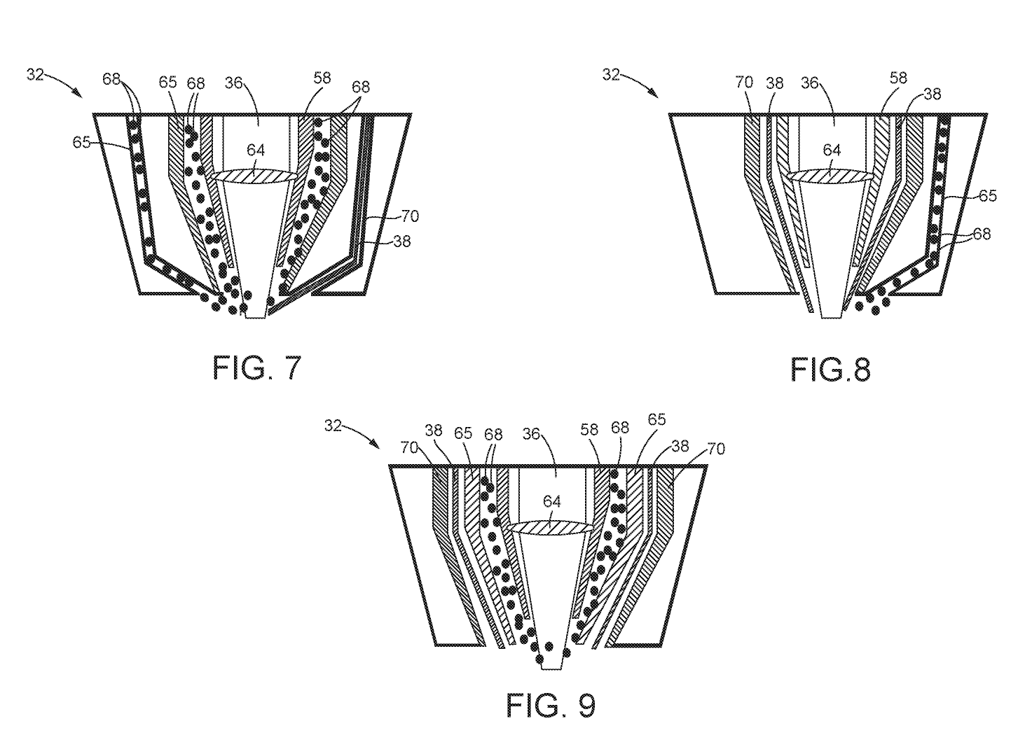

In other alternative arrangements, the nozzle 32 may include a laterally disposed powder channel 65 in addition to or in place of the coaxial powder channel, as shown in FIG. 7. As yet another alternative, one or more wire channels 70 may be coaxial to the laser channel 58 and one or more powder channels 65 may be laterally disposed, as shown in FIG. 8. In another arrangement, both the powder channel 65 and one more wire channels 70 may be coaxial to the laser channel 58, as shown in FIG. 9. Variations such as these also fall within the scope of the present disclosure.

As will be understood by those with ordinary skill in the art, the nozzle 32 may also include additional features such as one or more cooling channels for cooling the nozzle 32, and/or one or more shielding gas channels for shielding the laser beam 36 and the powder and/or wire cladding material with an inert gas as it is projected to the substrate surface.

The hybrid laser cladding nozzle 32 disclosed herein offers many advantages over laser cladding nozzles of the prior art that are limited to either powder feeding or wire feeding. By combining powder feeding and wire feeding, the laser cladding nozzle 32 disclosed herein offers the opportunity to blend cladding materials available in powder and wire form. For instance, as wire feeding alone has a low capacity for hard particles, a cladding layer 23 with a high hard particle content (more than about 35% by volume) may be produced by co-depositing or subsequently depositing hard particles in powder form. Moreover, powder feeding may be leveraged during or after wire deposition to smoothen out and improve the thickness uniformity of an uneven surface caused by poor wire detachment from the melt pool. Powder feeding may also be leveraged to provide multidirectional deposition of the cladding materials that cannot be realized with single wire feeding alone. Multidirectional deposition may also be realized by feeding the wires 38 onto the surface through multiple wire channels 70 laterally distributed around the laser channel 58, as described above.

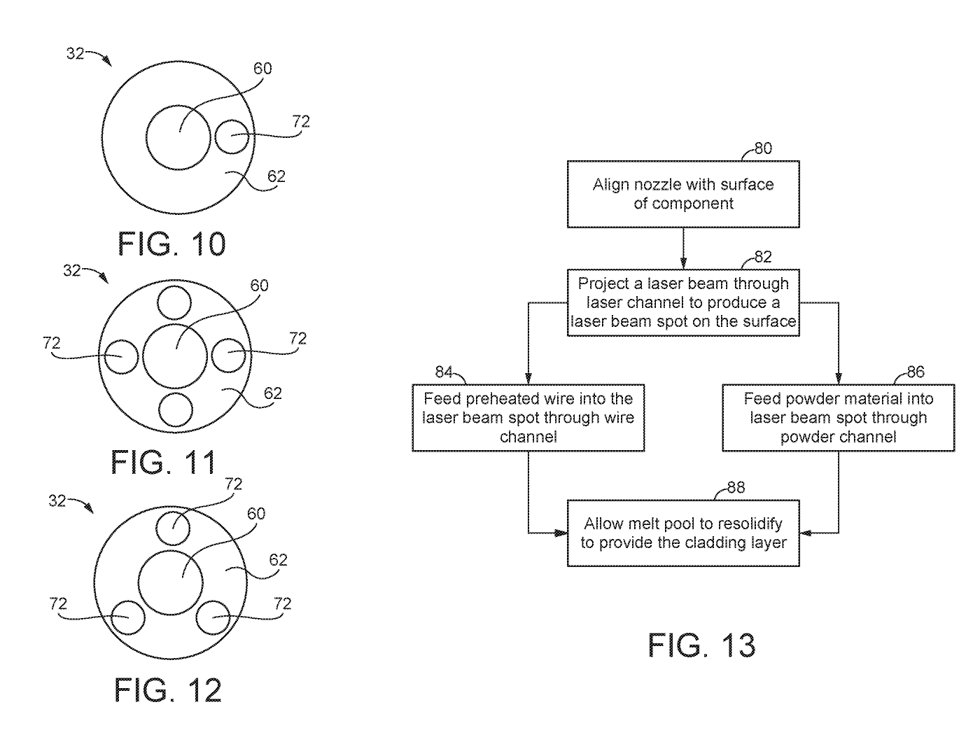

Turning now to FIG. 10, the nozzle tip 62 of the nozzle 32 of FIG. 5 is shown. If the nozzle 32 includes a single wire channel 70, the nozzle tip 62 may have one wire opening 72 through which the wire 38 exits the wire channel 70 and the nozzle 32. The wire opening 72 may be located radially outward of the nozzle opening 60 through which the laser beam 36 and the powder material 68 exit the nozzle. Alternatively, if the nozzle 32 includes a plurality of wire channels 70, the nozzle tip 62 may have a separate wire opening 72 for each of the wire channels 70. For example, the nozzle 34 may have four wire channels 70 equally spaced and laterally distributed around the laser channel 58 and the powder channel 65, and the nozzle tip 62 may have four wire openings 72 equally distributed around the nozzle opening 60, as shown in FIG. 11. In this arrangement, the wire openings 72 may be spaced by about 90° from each other around the nozzle opening 60. In another alternative arrangement, the nozzle 32 may have three wire channels 70 equally distributed around the laser channel 58 and the powder channel 65, such that the tip 62 includes three wire openings 72 equally distributed (by about 120°) around the nozzle opening 60 (see FIG. 12). It will be understood that the nozzle tip arrangements depicted in FIGS. 10-12 are non-limiting examples, and that the nozzle 32 may have any number of wire channels 70 and wire openings 72. Furthermore, in some cases, the wire channels 70/wire openings 72 may be unequally spaced or asymmetrically positioned about the nozzle 32 and the nozzle tip 62.

### INDUSTRIAL APPLICABILITY

In general, the teachings of the present disclosure may find applicability in many industries including, but not limited to, industries using components with cladding layers. More specifically, the teachings of the present disclosure may be applicable to any industry relying on laser cladding to produce wear-resistant cladding layers on wear components.

FIG. 13 shows a series of steps that may be involved in applying the cladding layer 23 to the wear component 12 using the laser cladding system 29. The head 30/nozzle 32 of the system 29 may be aligned with the surface 26 of the substrate 24, and the laser beam 36 may be projected through the laser channel 58 to produce the laser beam spot 54 on the surface 26 according to the blocks 80 and 82. The laser beam spot 54 may at least partially melt the surface 26 of the substrate 24 to produce the melt pool 56. During the block 82, one or more preheated wires 38 may be fed into the laser beam spot 54 through one or more of the wire channels 70 according to a block 84. The wire(s) 38 may contain the metal matrix and a low content of hard particles (less than about 35% by volume), and may melt and blend with the melt pool 56. To build up the hard particle content beyond the holding capacity of the wire(s) 38, the powder material 68 containing hard particles may be fed through the powder channel 65 into the laser beam spot 54/melt pool 56 according to a block 86. Optionally, the powder material may also contain a metal matrix of a same or different composition as the metal matrix of the wire(s) 38. The blocks 84 and 86 may be carried out simultaneously, or separately. As a non-limiting example, the cladding layer 23 may be fabricated by first applying the wire(s) 38 to the surface 26 through the wire channel 70 (block 84), followed by one or more final passes with the powder material 68 through the powder channel 65 (block 86) to boost the hard particle content in the melt pool 56. Following application of the powder material 68 and the wire(s) 38, the melt pool 56 may be permitted to cool and resolidify to provide the cladding layer 23 fused and bonded to the surface 26 of the substrate 24 (block 88). It will be understood that the method of FIG. 13 may be adapted to blend other types of powder and wire compositions as well. For instance, different metal matrices and/or hard particles may be blended via deposition through different wire channels 70 and/or the powder channel 65. Alternatively, it may be adapted to improve the thickness uniformity and/or the smoothness of a cladding layer deposited by rastered wire deposition by using simultaneous or subsequent powder feeding. Many other adaptations such as these are also encompassed within the scope of this disclosure.

The hybrid laser cladding system disclosed herein permits deposition of cladding layers via either or both of powder feeding and wire feeding. Simultaneous powder feeding and wire feeding may allow for higher deposition rates than can be achieved with just powder or wire feeding alone. In addition, as disclosed herein, the hybrid laser cladding system may be used to deposit cladding layers with hard particle contents well above the holding capacity of wire (about 35% by volume) by allowing the simultaneous or subsequent deposition of hard particles in powder form. Thus, the wear-resistance and/or abrasive properties of the resulting cladding layers may be significantly improved over cladding layers fabricated by wire feeding alone. Alternatively or in combination with this, compositional gradients in the cladding layer may be produced with the hybrid nozzle by gradually increasing the feeding rate of the powder or wire material. Moreover, multidirectional deposition may be achieved by either or both of powder feeding and wire feeding though multiple wire channels distributed around the nozzle. The hybrid nozzle also allows rough and uneven surfaces caused by wire feeding to be corrected with simultaneous or subsequent powder feeding. Further, components having distinct core and surface composition may be fabricated using by first building the core of the component by wire feeding, and then depositing an outer layer of distinct composition by powder feeding. Many possibilities such as these may be envisioned. It is expected that the technology disclosed herein may find wide industrial applicability in a wide range of areas such as, but not limited to, additive manufacturing, road construction, construction, agriculture, mining, automotive, marine, power generation, and aerospace applications.

What is claimed is:

1. A hybrid laser cladding nozzle configured to both powder feed and wire feed a cladding layer onto a substrate surface, comprising:
a central laser channel configured to project a laser beam onto the substrate surface to produce a laser beam spot thereon;
a powder channel coaxial to the laser channel and being configured to feed a powder material onto the laser beam spot; and
at least one wire channel laterally disposed with respect to the central laser channel and the powder channel, the wire channel being configured to feed a wire onto the laser beam spot, the laser beam spot being configured to at least partially melt the powder material and the wire to produce the cladding layer on the substrate surface.

2. The hybrid laser cladding nozzle of claim 1, wherein the laser cladding nozzle further comprises a nozzle tip having a nozzle opening, wherein the laser channel projects the laser beam onto the laser beam spot through the nozzle opening, and wherein the powder channel feeds the powder material onto the laser beam spot through the nozzle opening.

3. The hybrid laser cladding nozzle of claim 2, wherein the nozzle tip further includes a wire opening surrounding the nozzle opening, and wherein the wire channel feeds the wire onto the laser beam spot through the wire opening.

4. The hybrid laser cladding nozzle of claim 3, wherein the nozzle includes a plurality of wire channels each laterally disposed with respect to the laser channel and the powder channel, and wherein each of the wire channels are configured to feed the wire onto the laser beam spot through a separate wire opening.

5. The hybrid laser cladding nozzle of claim 4, wherein the nozzle tip includes a plurality of wire openings, and wherein the wire openings are distributed around the nozzle opening.

6. The hybrid laser cladding nozzle of claim 5, wherein the hybrid laser cladding nozzle includes four wire channels laterally distributed around the laser channel and the powder channel, and wherein the nozzle tip includes four wire openings spaced about 90° from each other around the nozzle opening.

7. The hybrid laser cladding nozzle of claim 5, wherein the hybrid laser cladding nozzle includes three wire channels laterally distributed around the laser channel and the powder channel, and wherein the nozzle tip includes three wire openings spaced about 120° from each other around the nozzle opening.

8. The hybrid laser cladding nozzle of claim 1, wherein the wire includes a metal matrix and the powder material includes hard particles.

9. The hybrid laser cladding nozzle of claim 8, wherein the metal matrix is selected from the group consisting of iron, nickel, cobalt, titanium, aluminum, alloys of any of the aforementioned metals, and combinations thereof.

10. The hybrid laser cladding nozzle of claim 9, wherein the hard particles are selected from the group consisting of carbide particles, boride particles, nitride particles, diamond pellets, and mixtures thereof.

11. A hybrid laser cladding system for depositing a cladding layer onto a surface of a substrate by powder feeding and wire feeding, comprising:
a fixture configured to support the substrate;
a laser cladding head having a laser cladding nozzle including a nozzle tip with a nozzle opening and a wire opening, the laser cladding nozzle further including a central laser channel configured to project a laser beam through the nozzle opening onto the surface of the substrate to produce a laser beam spot on the surface, a powder channel coaxial to the laser channel and being configured to feed a powder material onto the laser beam spot through the nozzle opening, and at least one wire channel laterally disposed with respect to the laser channel and the powder channel and being configured to feed a wire onto the laser beam spot through the wire opening, the laser beam spot being configured to at least partially melt the powder material and the wire to produce the cladding layer on the surface of the substrate;
a laser power supply configured to produce the laser beam; and
a hot wire power supply configured to preheat the wire in the wire channel.

12. The hybrid laser cladding system of claim 11, wherein the laser cladding system is capable of depositing at least 20 pounds per hour of the cladding layer on the surface of the substrate.

13. The hybrid laser cladding system of claim 12, wherein the laser cladding nozzle is configured to co-feed the powder material and the wire onto the laser beam spot.

14. The hybrid laser cladding system of claim 13, wherein the laser cladding system further includes a user-actuatable switch permitting a user to select between powder feeding, wire feeding, and a combination of powder feeding and wire feeding.

15. The hybrid laser cladding system of claim 13, wherein the powder material includes hard particles, and wherein the wire includes a metal matrix.

16. The hybrid laser cladding system of claim 13, wherein the powder material consists of a metal matrix and hard particles, and wherein the wire consists of a metal matrix and less than about 35% by volume of hard particles.

17. The hybrid laser cladding system of claim 13, wherein the laser cladding nozzle includes a plurality of wire channels equally spaced and laterally distributed around the laser channel and the powder channel, and wherein each of the wire channels are configured to feed the wire onto the laser beam spot through separate wire openings distributed around the nozzle opening.

18. The hybrid laser cladding system of claim 17, wherein the laser cladding nozzle includes four wire channels distributed around the laser channel and the powder channel, and wherein each of the four wire channels are configured to feed the wire onto the laser beam spot through a respective of one of four wire openings.

19. A wear component having a body with a metallic surface and a cladding layer deposited on the surface, the cladding layer being deposited on the surface of the wear component by a method comprising:
aligning a laser cladding nozzle with the surface, the laser cladding nozzle including a laser channel, a powder channel coaxial to the laser channel, and at least one wire channel laterally disposed with respect to the laser channel and the powder channel;
projecting a laser beam through the laser channel onto the surface of the component produce a laser beam spot, the laser beam spot at least partially melting the surface to produce a melt pool at the laser beam spot;
feeding a wire through the wire channel onto the laser beam spot, the wire including a metal matrix;
feeding a powder material through the powder channel onto the laser beam spot, the powder material including hard particles; and
allowing the melt pool to resolidify at the surface of the component to provide the cladding layer.

20. The wear component of claim 19, wherein feeding the powder material through the powder channel and feeding the wire through the wire channel are carried out simultaneously.
